(19) United States
(12) Patent Application Publication
(10) Pub. No.: US 2025/0083496 A1
(43) Pub. Date: Mar. 13, 2025

(54) WINDOW REGULATOR ASSEMBLY OF A MOTOR VEHICLE AND SLIDE SHOE OF A WINDOW REGULATOR ASSEMBLY

(71) Applicant: Brose Fahrzeugteile SE & Co. Kommanditgesellschaft, Bamberg, Bamberg (DE)

(72) Inventors: Matthias HEPPNER, Burgkunstadt (DE); Jörg MÜLLER, Ahorn (DE); Mark WAGNER, Breitengüssbach (DE)

(21) Appl. No.: 18/883,041

(22) Filed: Sep. 12, 2024

(30) Foreign Application Priority Data
Sep. 12, 2023 (DE) 10 2023 208 866.5

(51) Int. Cl. B60J 1/17; E05F 11/44; E05F 11/48

(52) U.S. Cl. CPC B60J 1/17; E05F 11/445; E05F 11/483; E05Y 2600/626; E05Y 2900/55

(57) ABSTRACT

A window regulator assembly of a motor vehicle includes a guide rail on which a slide shoe is longitudinally movably mounted. The slide shoe has a main bracket which is mounted on the guide rail, and has a clamping arrangement. The clamping arrangement includes a clamping bracket connected to the main bracket and includes a pressure plate disposed parallel to the clamping bracket. A clamping component is clamped between the clamping bracket and the pressure plate. The clamping component holds a window pane. The clamping component has a holding surface which is disposed parallel to the pressure plate and a spacing between the holding surface and the clamping bracket is adjustable. A slide shoe of a window regulator assembly is also provided.

### CROSS-REFERENCE TO RELATED APPLICATION

This application claims the priority, under 35 U.S.C. § 119, of German Patent Application DE 10 2023 208 866.5, filed Sep. 12, 2023; the prior application is herewith incorporated by reference in its entirety.

### FIELD AND BACKGROUND OF THE INVENTION

The invention relates to a window regulator assembly of a motor vehicle, which includes a slide shoe. The invention also relates to a slide shoe.

Motor vehicles such as passenger cars commonly have multiple window panes that can be moved relative to a body of the motor vehicle. For that purpose, use is commonly made of a window regulator assembly through the use which the window pane, which for example forms part of the window regulator assembly or is separate therefrom, is moved. Such a window regulator assembly is commonly disposed in a vehicle door, the door body of which generally has a door outer part, which forms the outer skin of the vehicle door, and an inner part, which is connected as a door inner trim panel to the door outer part. Formed between the inner part and the door outer part is an installation space in which functional elements of the vehicle door, and in particular the window regulator assembly, are accommodated. The window regulator assembly normally includes a carrier component, also referred to as carrier plate or door module carrier, for components of a window regulator and optionally for a door lock, an airbag sensor, a loudspeaker and other functional elements. The carrier component also serves as a so-called wet space/dry space divider and divides the cavity into a wet space side, which faces the door outer part and into which moisture can ingress via a slot-like window opening of the vehicle door, and a dry space side, which faces the door inner part.

The window regulator assembly normally includes an electromotive actuating drive and, in the case of a single-cable window lifter, a single guide rail and, in the case of a two-cable window lifter, two guide rails, on which slide shoes or drivers that are connected to a window pane (vehicle window pane) are guided to perform sliding movements. Those in turn are coupled via a flexible traction cable to the actuating drive for the purposes of moving the window pane along an adjustment travel between a closed position and an open position. The slide shoes (drivers) are generally disposed in the region of a bottom edge of the window pane and connected to the window pane there.

For example, the window pane is assigned an encircling guide that is provided by an encircling window frame, as is the case for example in sedan vehicles. It is however also possible for such a window regulator assembly to be used in a frameless door, which is for example part of a cabriolet or coupe. In such a door, no further guide for the window pane is provided above the door outer part. A preload is required there to ensure sealing contact of the window pane against, for example, a roof of the motor vehicle. For that purpose, the guide rails are inclined to a greater degree relative to the vertical in such a way that, in the closed state, the window pane is pressed against a seal that is disposed on the roof or on the body. In order to provide the preload, the two guide rails that may be provided are for example correspondingly inclined. It is however also possible for only one of the two guide rails to be correspondingly finely adjusted, normally the so-called B-side guide rail, that is to say in particular the guide rail on the side remote from the hinge in the case of a driver's door. At the front side in a direction of travel, the window pane is introduced into a guide groove which serves as an axis of rotation during an adjustment of the B-side guide rail.

With such an approach, it is possible for the A-side guide rail to be installed fixedly, that is to say in particular so as not to provide adjustability. It is also possible for the guide rail to be integrated into the door module. That reduces production costs and simplifies installation. Undesired distortion of the window plane can however occur during operation, which can lead to damage to the window pane or at least increased wear of any seals. Depending on the configuration, sluggish movement may also occur.

### SUMMARY OF THE INVENTION

It is accordingly an object of the invention to provide a particularly suitable window regulator assembly of a motor vehicle and a particularly suitable slide shoe of a window regulator assembly, which overcome the hereinafore-mentioned disadvantages of the heretofore-known devices of this general type and with which wear is advantageously reduced and, expediently, the occurrence of sluggish movement is reduced and/or installation is facilitated.

With the foregoing and other objects in view there is provided, in accordance with the invention, a window regulator assembly of a motor vehicle, having a guide rail on which a slide shoe is longitudinally movably mounted, which slide shoe has a main bracket, which is mounted on the guide rail, and has a clamping arrangement, which includes a clamping bracket connected to the main bracket and includes a pressure plate disposed parallel to the clamping bracket, between which clamping bracket and pressure plate there is clamped a clamping component that holds a window pane, wherein the clamping component has a holding surface which is disposed parallel to the pressure plate and the spacing of which to the clamping bracket is adjustable.

With the objects of the invention in view, there is also provided a slide shoe of a window regulator assembly, which slide shoe has a main bracket for mounting on a guide rail and has a clamping arrangement, which clamping arrangement includes a clamping bracket connected to the main bracket and includes a pressure plate disposed parallel to the clamping bracket, between which clamping bracket and pressure plate there is disposed a clamping component for holding a window pane, wherein the clamping component has a holding surface which is disposed parallel to the pressure plate and the spacing of which to the clamping bracket is adjustable.

The respective subclaims relate to advantageous refinements and embodiments.

The window regulator assembly, when installed, is part of a motor vehicle, and is therefore suitable, intended and configured for this purpose. The motor vehicle is in particular a land vehicle, and preferably of multi-track configuration. Here, it is suitably possible for the motor vehicle to be positioned substantially freely, in particular on a roadway. For this purpose, the motor vehicle expediently has corresponding wheels. In summary, it is preferably possible for the motor vehicle to be positioned on land substantially independently of other conditions. In other words, the motor vehicle is suitably not rail-guided. The motor vehicle is preferably a passenger car or a utility vehicle such as a truck or bus.

Here, the window regulator assembly serves in particular for adjusting a window pane of the window regulator assembly relative to a body of the motor vehicle. The window regulator assembly is preferably part of a door of a motor vehicle, in particular of a side door. The door has, for example, a frame that surrounds the window pane (at least in the closed state). It is however preferred that the door is frameless and, in the closed state, in particular of the doors and of the window pane, the window pane bears at least partially, at an edge, against a roof of the motor vehicle, which is for example of rigid construction or can be adjusted, that is to say is in particular a cabriolet roof or a coupe roof.

The window regulator assembly has a guide rail. The guide rail is formed for example from aluminum or steel. A slide shoe is mounted longitudinally movably on the guide rail, and the guide rail serves in particular for guiding the slide shoe to perform sliding movements. The guide rail is at least suitable, in particular intended and configured, for guiding the slide shoe. In the installed state, the guide rail is expediently fastened rigidly to an associated component, such as a door module or a door bodyshell/door body.

The slide shoe includes a main bracket that is mounted on the guide rail. In particular, the guide rail and the slide shoe have structures that engage into one another in such a way that only a movement of the slide shoe in a longitudinal direction of the guide rail is possible. Here, the guide rail is preferably of L-shaped form at least at an edge, and inserted into a corresponding L-shaped receptacle of the main bracket. Here, the main bracket is for example formed as a single piece or preferably has one body, which is for example manufactured from a metal or plastics material. The body in turn has a receptacle, into which there is inserted a clip which surrounds the guide rail. The clip is manufactured in particular from a plastics material such as POM or PTFE. Excessive friction is thus avoided. Adaptation to different guide rails is also made possible in this way. Irrespective of the configuration of the main bracket, the main bracket is expediently mounted rotationally rigidly on the guide rail.

The slide shoe preferably includes a cable attachment, also referred to as a dowel chamber. A cable is held by the cable attachment, at least in the installed state. The cable is manufactured in particular from a wire or from plastics material. For example, the cable is clamped in the dowel chamber, for example by a clamp. Alternatively or in combination with this, one or more sleeves or the like is or are mounted on, and for example pressed together with, the cable, in particular at an end. Here, the cable attachment has a corresponding chamber into which the sleeve is inserted, wherein, in particular, the sleeve can be removed from the chamber only by way of a movement perpendicular to the course of the cable. Due to the cable attachment, when the cable is pulled parallel to the guide rail, the slide shoe is moved parallel to the guide rail. It is preferable for one or more diverting rollers to be mounted on the guide rail, which diverting rollers guide the cable or the like that is held on the slide shoe. The diverting rollers thus ensure that the cable runs substantially parallel to the guide rail in the region of the slide shoe.

The slide shoe furthermore includes a clamping arrangement that has a clamping bracket and a pressure plate disposed parallel thereto. Here, the clamping bracket and the pressure plate are in particular configured to be adjustable relative to one another and are preferably fastened to one another by a clamping screw. In particular, a maximum spacing of the clamping bracket to the pressure plate is predefined by the clamping screw. A clamping component is clamped between the clamping bracket and the pressure plate. The clamping component, in turn, holds the window pane. In particular, the clamping bracket is disposed substantially parallel to the main bracket. The clamping bracket is situated in particular between the pressure plate and the main bracket. Accessibility to the pressure plate is thus provided. The clamping screw is preferably guided through the pressure plate and screwed into the clamping bracket. In particular, by virtue of the clamping screw being rotated, the pressure plate is moved toward/away from the clamping bracket, or at least the maximum spacing between these is predefined.

The clamping component has a holding surface that is disposed parallel to the pressure plate. The holding surface is thus also disposed parallel to the clamping bracket. Here, the holding surface is in particular disposed between, and in particular clamped by, the pressure plate and the clamping bracket. For example, the holding surface lies mechanically directly against the window pane. The window pane, which is in particular disposed at least partially between the pressure plate and the clamping bracket, is thus also clamped by the holding surface. In particular, the window pane is disposed between the holding surface and the clamping bracket or particularly preferably between the holding surface and the pressure plate. The holding surface is in this case preferably formed from a plastics material or rubber, in such a way that a mechanical load on the window pane is reduced.

Alternatively, the clamping component additionally includes, for example, a fork-shaped holding element that is held by the holding surface. Here, the holding element is for example fastened to, or in particular clamped by, the holding surface. The holding element is in particular fork-shaped and preferably has a receptacle which, in the installed state, is disposed vertically above the pressure plate and/or the clamping bracket. The receptacle engages around an edge of the window pane, which is in particular a composite glass pane.

The position of the window pane relative to the main bracket, and thus also relative to the guide rail, is at least implicitly predefined by the holding surface. The spacing of the holding surface to the clamping bracket is adjustable. In other words, the spacing is variable. For example, the spacing results automatically from a configuration of the slide shoe and/or of the window regulator assembly. Alternatively, it is preferably possible to fix the spacing, in particular in different positions. Since the spacing of the holding surface to the clamping bracket is adjustable, it is possible for the spacing to be adapted to the position of the window pane, with no adaptation of the guide rail being necessary. Due to the adaptation, distortion of the window pane is avoided. The window pane is in particular also not elastically deformed, in such a way that it is not pressed with excessive force against any seal or the like, whereby friction and wear are reduced. Sluggish movement caused by distortion of the window pane, which could for example lead to erroneous activation of an anti-trap function, is also avoided. Convenience and reliability are thus also increased. It is also possible for the guide rail and the window pane to always be installed in the same way, and for no adjustability to be provided there. Material costs are thus reduced, and a processing speed during assembly is increased.

It is furthermore possible for the position of the window pane relative to the clamping bracket and thus also relative to the guide rail to be varied by the holding surface. It is thus also possible for a contact pressure of the window pane against any seal in the closed state to be varied by the holding surface without the need for the guide rail and the fastening thereof to be adapted. Fine readjustment is thus facilitated.

For example, the window regulator assembly includes only one guide rail. The window regulator assembly however particularly preferably includes a second guide rail on which a second slide shoe is longitudinally movably mounted, which second slide shoe also holds the window pane, in particular by a correspondingly associated clamping component. In particular, the cable is likewise held by the second slide shoe.

For example, the two slide shoes are structurally identical, in such a way that identical parts can be used, thus reducing production costs. For example, in the installed state, the second guide rail is fastened rigidly to, or integrated in, the associated component, such as a door module or a door body shell/door body. Alternatively, the second guide rail is fastened adjustably to the component. By adjusting the second guide rail, it is preferably possible here to adjust a preload of the window pane against any seal, which is disposed for example in the region of a roof of the motor vehicle. The resulting offset in the region of the guide rail can in this case be compensated through corresponding positioning of the holding surface, with no adjustment of the associated guide rail being necessary. Assembly/maintenance/fine adjustment is thus facilitated. In summary, it is possible to adjust the preload merely by fine adjustment of one of the guide rails, namely the second guide rail, wherein the adaptation of the to the adjusted window pane is performed at the remaining guide rail, which has the adjustable holding surface. Here, the second guide rail is suitably assigned to a B pillar, whereas the guide rail that is assigned the slide shoe having the adjustable holding surface is assigned to an A pillar of the motor vehicle.

The window regulator assembly preferably includes a guide groove which is disposed parallel to the guide rail and which engages around an edge of the window pane. Here, during movements of the window pane, in particular during movements of the slide shoe along the guide rail, the window pane is moved within the guide groove.

For example, the window regulator assembly furthermore includes an actuating drive, which drives the cable that is guided around the diverting rollers that may be provided. The actuating drive preferably includes an electric motor that drives, for example, a transmission such as a worm gear transmission. The transmission, or at least the electric motor, preferably drives a cable drum around which the cable is looped. Thus, when the actuating drive is operated, the window pane is adjusted.

For example, the holding surface is loose relative to the clamping bracket and/or the pressure plate. The holding surface is however particularly preferably mounted on the clamping arrangement. Detachment of the holding surface from the clamping arrangement is thus avoided, thus increasing robustness and facilitating installation, in particular of the window pane. For example, the holding surface is mounted on the pressure plate. The holding surface is however particularly preferably mounted on the clamping bracket. The position at which the window pane is situated relative to the clamping bracket is thus foreseeable, even when the window pane and/or the pressure plate have not yet been installed. It is thus also possible in particular for the holding surface and the clamping bracket to be formed as one module, thus facilitating installation.

For example, to adjust the spacing, the holding surface is integrally bonded to the clamping bracket, for example by adhesive bonding or welding. The holding surface is however particularly preferably mounted so as to be movable relative to the clamping bracket. Here, the slide shoe suitably has an adjusting screw through the use which, in particular, the spacing can be adjusted. Here, the adjusting screw acts on the holding surface. It is thus possible in particular for the spacing to be adjusted by rotating the adjusting screw. For example, the holding surface is clamped against the clamping bracket by the adjusting screw, or the adjusting screw bears at an end against the holding surface and is for example screwed into the clamping bracket. The adjusting screw allows relatively fine tuning of the spacing, that is to say a fine adjustment, wherein retroactive alteration and/or adaptation is also made possible. Also, no special tool is required for this purpose.

The slide shoe particularly preferably includes an angular gearing which has the adjusting screw. Here, the adjusting screw is disposed parallel to the clamping bracket, and, in particular, force is exerted on the holding surface by the angle bracket. Rotation of the adjusting screw by the angular gearing, which is for example a 90° gearing, thus causes a force to be exerted on the holding surface in such a way that the holding surface is adjusted relative to the clamping bracket. For example, the angular gearing is of self-locking configuration, in such a way that the holding surface is stabilized when the adjusting screw is not being rotated. The position of the holding surface is thus relatively stable even when the window pane has not yet been installed. The adjusting screw is expediently situated between the clamping bracket and the main bracket so as to be protected. The parallel arrangement means that retroactive operation of the adjusting screw, and thus a variation of the position of the holding surface, are nevertheless made possible. In summary, operation of the adjusting screw is possible even when the clamping bracket has been disposed on the main bracket and/or the window pane has already been installed.

For example, one or more pins or the like are connected to the holding surface, the pins being inserted into corresponding receptacles of the clamping bracket. Here, the pin and/or the receptacles extend for example substantially perpendicular to the clamping bracket and the holding surface. The clamping bracket however particularly preferably includes multiple guide slots, into which in each case one bearing wing that is connected to the holding surface is inserted. The guide slots and/or the bearing wings are in this case preferably structurally identical to one another. The bearing wings are expediently substantially L-shaped, wherein the holding surface is offset away from the clamping bracket due to the L shape. The extent of each bearing wing in the associated guide slot is in this case smaller than the length of the particular guide slot. It is thus possible for the bearing wings to be moved in the guide slots, and thus also for the holding surface to be moved relative to the clamping bracket. The clamping bracket preferably includes four guide slots, with four corresponding bearing wings thus being connected to the holding surface. The bearing wings are suitably formed integrally on the holding surface, and thus as a single piece with the latter, thus facilitating production. In particular, the bearing wings have, at an end, a latching lug or a clip, or these are connected to the ends of the bearing wings. Through the use these, each bearing wing is latched to the associated guide slot, in such a way that removal is possible only by deformation of the clips or of the latching lugs.

The guide slots are inclined relative to the holding surface and are therefore also inclined relative to the clamping bracket. In other words, an angle not equal to 90° or 0° is formed between each guide slot and the holding surface. An angle of between 5° and 30° is suitably formed between these. It is thus possible for the holding surface to be moved obliquely relative to the clamping bracket, and thus for the spacing of these to one another to be adjusted. Here, all guide slots and the corresponding bearing wings are suitably inclined by the same angle.

Due to the oblique mobility of the holding surface relative to the clamping bracket, the clamping force that is provided by the pressure plate and the clamping bracket and optionally the clamping screw acts not only in the direction in which the holding surface can be moved relative to the clamping bracket. A required robustness of the holding surface and of the mounting on the clamping bracket is thus reduced. Also, if the adjusting screw and/or the angular gearing is provided, a force acting thereon due to the clamping is reduced, in such a way that the required robustness thereof is likewise reduced, with an undesired adjustment of the holding surface relative to the clamping bracket nevertheless being avoided.

For example, the window pane or the holding element that may be provided is clamped between holding surface and the pressure plate. A second holding surface of the clamping component is however particularly preferably connected to the pressure plate. The second holding surface is preferably formed from a plastics material and/or rubber, in such a way that damage to the components disposed between the two holding surfaces is avoided, wherein a relatively high clamping force can nevertheless be imparted by the clamping arrangement.

For example, the second holding surface is fastened rigidly to the pressure plate. Alternatively, the second holding surface is mounted on the pressure plate in such a way that, in particular, a spacing of the second holding surface to the pressure plate is also variable. Here, it is for example possible for the spacing to likewise be adjusted, or the spacing preferably results from an adjustment of the spacing of the holding surface to the clamping bracket. The two holding surfaces are preferably structurally identical to one another, in such a way that identical parts can be used. Here, the second holding surface is expediently mounted by corresponding guide slots in the pressure plate, which guide slots are in particular parallel to the guide slots that may be provided in the clamping bracket. In particular, corresponding bearing wings are connected to the second holding surface for this purpose.

For example, the clamping arrangement is fastened rigidly to the main bracket, and the clamping bracket is preferably formed as a single piece with, and thus integrally on, the main bracket. Production is thus facilitated. The clamping arrangement is alternatively mounted so as to be adjustable relative to the main bracket. In other words, it is possible to adjust the clamping arrangement relative to the main bracket, for example once during an installation process, several times, in particular during the course of a workshop visit, or preferably also during operation. In particular, the clamping arrangement is of substantially self-adjusting configuration. Here, it is possible in particular for the clamping arrangement to be adjusted transversely and/or in rotation relative to the main bracket. The adjustability of the clamping arrangement additionally makes it possible for the clamping arrangement to be adapted to the position and/or orientation of the window pane, which further reduces distortion of the window pane. For example, an offset is thus compensated which cannot be compensated merely by adjusting the spacing. Also, for example, a fine adjustment is performed by adjusting the spacing, whereas a relatively coarse adjustment is performed by adjusting the clamping arrangement relative to the main bracket.

For example, the main bracket is likewise adjustable relative to the cable attachment. Here, it is possible in particular for the main bracket to be adjusted relative to the cable attachment parallel to the guide rail. It is thus possible to compensate for tolerances of the cable and/or of the position of the sleeve that may be provided, and/or for example for a lengthening of the cable that results from operation. In other words, a fine readjustment is likewise made possible there, in such a way that the same cable can be used throughout the entire service life of the window regulator assembly.

Alternatively, the main bracket is fastened rigidly to the cable attachment. Robustness is thus increased. Here, the slide shoe preferably has a threaded spindle through the use which the clamping arrangement is mounted on the main bracket. Here, the threaded spindle extends parallel to the guide rail, and it is possible through the use the threaded spindle for the clamping arrangement to be adjusted relative to the main bracket parallel to the guide rail, at least within certain limits. For example, a spindle nut is mounted onto the threaded spindle, which spindle nut is for example fastened rigidly to, or mounted rotatably on, the main bracket or the clamping arrangement. The spindle nut is mounted rotatably on the other component in each case. Thus, when the threaded rod is rotated, the clamping arrangement is adjusted relative to the main bracket. Adjustability and relatively precise fine adjustment are thus made possible due to the threaded spindle, with no special tool being required. Through the use this adjustment, it is thus possible for the window pane to be moved parallel to the guide rail and for any tolerances to be compensated. This is performed during the course of a fine adjustment, and the position of the cable is not changed in the process.

For example, the adjustability of the clamping arrangement relative to the main bracket is implemented here by the threaded spindle. Due to the rigid connection of the main bracket to the cable attachment, it is therefore not possible for these to be adjusted relative to one another, as a result of which the position of the main bracket on the guide rail, in particular relative to its ends, is predefined merely by the cable and cannot be varied. It is therefore not necessary for the guide rail to be of lengthened configuration in order to allow the fine adjustment/adjustment. This is rather performed by the clamping arrangement, which may for example protrude beyond the end of the guide rail. It is consequently possible for the guide rail to be of shortened configuration. Also, the threaded spindle and the cable attachment are preferably situated on opposite sides in relation to the guide rail. A relatively compact slide shoe is thus provided, and any tilting moments acting on the guide rail/the slide shoe are reduced. Robustness is thus increased, and it is possible for the interlocking structures, which may be provided, of the slide shoe and of the guide rail to be of shortened configuration.

Alternatively or in combination with the transverse adjustability, the clamping arrangement is mounted on the main bracket so as to be rotatable about an axis of rotation. The axis of rotation expediently extends parallel to the guide rail. In particular, any angle that may be present between the window pane and the main bracket is at least partially compensated due to the rotatable mounting. In particular, the rotatability makes it possible for the holding surface, the pressure plate and/or the clamping bracket to be disposed parallel to the window pane. Undesired distortion of the window pane, and/or clamping only at one point, is thus avoided. In particular if the second guide rail is provided, it is thus possible for the second guide rail to be inclined to a relatively great degree relative to the vertical or offset to a relatively great extent relative to a longitudinal axis of the motor vehicle. The guide groove is expediently provided here, which engages around the end of the window pane.

For example, the position of the clamping arrangement, in particular the angle between the clamping arrangement and the main bracket, is preset and is suitably predefined. The clamping arrangement is however particularly preferably mounted loosely on the main bracket. Automatic adjustment of the angle between the clamping arrangement and the main bracket is thus realized, thus simplifying installation. Here, when the slide shoe is moved along the window pane, the height of the window pane along the guide rail is nevertheless always predefined by the main bracket, for which reason, due to the loose mounting, no offset of the window pane, or jamming, occurs.

The slide shoe particularly preferably has an adjusting screw that is connected to the clamping arrangement. Here, the adjusting screw is in particular led through the clamping arrangement. For example, the adjusting screw is a separate component. Alternatively, the adjusting screw is formed for example through the use the clamping screw that is used to connect the pressure plate to the clamping bracket. The adjusting screw protrudes beyond the clamping arrangement, or at least beyond the clamping bracket or the pressure plate, on the side facing toward the main bracket. Here, the adjusting screw is configured and disposed, in particular screwed in, so as to be supported at an end against the main bracket. The (loose) adjustability of the clamping arrangement relative to the main bracket is thus limited in one direction by the adjusting screw.

For example, the slide shoe preferably has a hinge through the use which the clamping arrangement is connected to the main bracket. Here, the axis of rotation is disposed in particular at that end of the main bracket which faces away from the guide rail and/or from the cable attachment. Thus, when the clamping arrangement is rotated about the axis of rotation, the window pane is also moved away from the guide rail, in such a way that, in addition to the angular compensation, a spacing of the window pane to the guide rail is also adjusted, at least to a small extent or at least depending on the particular angle. For example, the main bracket is rigidly fastened to the cable attachment, or the main bracket is adjustable relative to the cable attachment parallel to the guide rail. By adjusting the spacing of the holding surface relative to the clamping bracket, this can for example be compensated, in such a way that the spacing of the window pane to the guide rail and the angle of the window pane relative to the guide rail can be chosen substantially freely.

Alternatively, the clamping arrangement is mounted by using the threaded spindle so as to be rotatable about the axis of rotation. Here, the threaded spindle is expediently disposed coaxially with respect to the axis of rotation. Preferably, in this case, the main bracket is fastened rigidly to the cable attachment, and thus, in particular, the offset of the clamping arrangement relative to the main bracket parallel to the guide rail is adjusted by using the threaded spindle, specifically by rotation of the threaded spindle. Here, the clamping arrangement, preferably the clamping bracket, has an insert through the use which the threaded spindle or the threaded nut that may be provided is mounted so as to be at least partially rotatable but is held fixed in a direction parallel to the guide rail. Due to the use of the threaded spindle for the rotatable mounting, the number of components required is reduced, whereby a weight and the production costs of the slide shoe are reduced. Also, the threaded spindle is disposed relatively close to the guide rail, in such a way that tilting of the slide shoe relative to the guide rail is avoided.

In another embodiment, the clamping arrangement is mounted pivotably on the main bracket by a ball joint. Here, the ball joint has a ball that is surrounded by a ball socket. A non-detachable connection of the ball socket to the ball is preferably provided here, thus increasing robustness. Through the use the ball joint, it is possible for the clamping arrangement to be pivoted relative to the main bracket about two mutually perpendicular axes. Stops or the like are preferably provided here, in such a way that a maximum angle by which the clamping arrangement can be pivoted relative to the main bracket is limited. The angle is preferably less than or equal to 10°, 5° or 2°. In particular, one of the stops, or some other structural measure, prevents a rotation of the clamping arrangement relative to the main bracket, in particular about an axis of rotation that extends substantially perpendicular to the main bracket and/or the clamping arrangement. The clamping component thus always points substantially in the same direction, preferably in a vertically upward direction, facilitating the installation of the window panes.

For example, the clamping arrangement is mounted loosely on the main bracket by the ball joint, resulting substantially in an independent adjustment of the angle of the clamping arrangement relative to the main bracket onto the window pane. Alternatively, for example, the ball joint exhibits tension through the use which the position of the ball relative to the ball socket, and thus of the clamping arrangement relative to the main bracket, can be held fixed. It is thus also possible for the position of the window pane to be predefined, in particular for a preload to be provided, by the slide shoe. The main bracket is for example rigidly fastened to the cable attachment that may be provided, or these are likewise movable relative to one another, in particular parallel to the guide rail, allowing relatively precise fine adjustment.

The ball joint expediently includes a ball-head screw that extends obliquely with respect to the guide rail. In other words, the ball-head screw is not disposed parallel to the guide rail, and the ball-head screw extends preferably perpendicular to the guide rail and/or in a horizontal plane. The ball-head screw has, at an end, the ball which, in the installed state, is at least partially surrounded by the ball socket. The ball-head screw is screwed into a corresponding hole. Preferably, the main bracket has the hole, and the clamping arrangement includes the ball socket into which the ball-head screw is inserted. In an alternative embodiment, it is for example the case that the clamping arrangement has the hole, and the main bracket includes the ball socket. Due to the use of the screw, it is also possible here for the ball to be spaced from the main bracket and thus also for the clamping arrangement to be spaced relative to the main bracket. In other words, the spacing of the clamping arrangement to the main bracket is predefined by virtue of the ball-head screw being screwed into the hole. An additional device for compensating a lateral offset of the window pane relative to the guide rail is thus provided, thus improving adjustability. In particular, the ball-head screw allows a relatively large degree of compensation, with this for example being possible only before the completion of the final assembly process. By contrast, by varying the spacing of the holding surface to the clamping bracket, fine adjustment is expediently possible, in particular even after the completion of the installation of the clamping arrangement on the main bracket, and/or when the window pane has already been installed or at least suitably positioned.

The slide shoe, when installed, is part of a window regulator assembly, and is suitable, intended and configured for this purpose. The slide shoe includes a main bracket for mounting on a guide rail, in particular for rotationally rigid mounting on the guide rail. The main bracket is in particular intended and configured for this purpose. For example, the main bracket is formed as a single piece. The main bracket however preferably includes a body that is expediently formed from a metal. The body in particular holds one or more clips or the like that are manufactured from a plastics material. In the installed state, these are inserted into the guide rail. Through the use the clips, damage to the guide rail is avoided, and friction is reduced. By contrast, relatively high mechanical integrity of the main bracket is provided by the body.

The slide shoe expediently includes a cable attachment, also referred to as a dowel chamber. The dowel chamber serves for holding a cable, in particular a wire or plastics material cable. The cable attachment preferably includes one or more chambers into which, in particular, a sleeve can be placed, which sleeve is mounted onto, and pressed together with, the cable. Alternatively, the cable attachment includes, for example, a clamping device or some other fixing element through the use which the cable can be held on the cable attachment, in such a way that detachment is prevented, at least when the cable is pulled.

The slide shoe furthermore includes a clamping arrangement that is connected to the main bracket. The clamping arrangement includes a clamping bracket and a pressure plate. Here, the clamping bracket is expediently situated on the side facing toward the main bracket, and the pressure plate is in particular fastened by a clamping screw to the clamping bracket. It is possible here for a maximum spacing of the pressure plate to the clamping bracket to be predefined by the clamping screw. The pressure plate and the clamping bracket are disposed parallel to one another and are preferably formed from the same material, for example from a metal, which increases robustness.

A clamping component is disposed, preferably clamped, between the clamping bracket and the pressure plate. The clamping component in turn serves to hold a window pane and is suitable, in particular intended and configured, for this purpose. For example, the inner sides, facing toward one another, of the clamping bracket and of the pressure plate are lined by the clamping component, and in the installed state, the window pane is disposed between the inner sides in such a way that a sandwich structure is formed. Here, the clamping component is preferably formed from a plastics material or rubber, and a clamping force is imparted to the window pane via the clamping component, in such a way that the window pane is also clamped between the clamping bracket and the pressure plate.

The clamping component has a holding surface which is disposed parallel to the pressure plate and thus also parallel to the clamping bracket. The spacing of the holding surface to the clamping bracket is adjustable. In other words, the spacing is variable. For example, the spacing results here from a configuration of the slide shoe. Alternatively, the spacing is expediently manually set, and the position of the holding surface relative to the clamping bracket can preferably be fixed in such a way that, after the preferred spacing has been set, a further movement of the holding surface relative to the clamping bracket is prevented.

The invention also relates to a motor vehicle. The motor vehicle is for example a land vehicle, for example a truck, a bus or preferably a passenger car. The motor vehicle has, for example, a body that includes an opening. The motor vehicle preferably has a door, which is in particular disposed in such a way that the opening can be covered by the door. Here, a hinge is expediently provided, through the use which the door is mounted on the body in such a way that the door can be moved, for example pivoted and/or at least partially moved along a longitudinal direction, relative to the body. The motor vehicle preferably has multiple doors, which are in particular each configured as side doors.

The motor vehicle has a window regulator assembly as described above, which is for example assigned to the door that may be provided. The motor vehicle suitably has multiple such window regulator assemblies, wherein, in particular, each door is assigned one of the window regulator assemblies. For example, the motor vehicle has yet further window regulator assemblies which are however not part of a door of the motor vehicle.

The axis of rotation, which may be provided, of the clamping arrangement, if the clamping arrangement is rotatable relative to the main bracket, extends in particular in the Z direction of the vehicle coordinate system. If the clamping arrangement can be adjusted transversely with respect to the main bracket, this preferably takes place in the Z direction, in such a way that any cable lengthening can be compensated.

The refinements and advantages discussed in connection with the window regulator assembly are analogously also transferable to the slide shoe/the motor vehicle and among one another and vice versa.

Other features which are considered as characteristic for the invention are set forth in the appended claims.

Although the invention is illustrated and described herein as embodied in a window regulator assembly of a motor vehicle and a slide shoe of a window regulator assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side-elevational view of a motor vehicle having a door that includes a window regulator assembly;

FIG. 2 is a side-elevational view of the window regulator assembly, which includes a window pane and a guide rail on which a slide shoe is mounted;

FIG. 3 is a horizontal-sectional view showing different possible fine adjustments of the window pane;

FIG. 4 is a fragmentary side view of the slide shoe mounted on the guide rail;

FIG. 5 is a fragmentary side view of a main bracket of the slide shoe;

FIG. 6 is a fragmentary side view of a clamping bracket of the slide shoe;

FIG. 7 is a fragmentary side view of an alternative configuration of the clamping bracket;

FIG. 8 is a side view of a ball-head screw;

FIG. 9 is a side view of the slide shoe having the clamping bracket according to FIG. 7;

FIG. 10 is a fragmentary, perspective view of a clamping arrangement which is formed by the pressure plate, the clamping bracket and a clamping part and through the use of which the window pane is held, wherein the clamping arrangement includes two holding surfaces; and

FIG. 11 is a fragmentary rear view of an angular gearing connected to the clamping carrier.

### DETAILED DESCRIPTION OF THE INVENTION

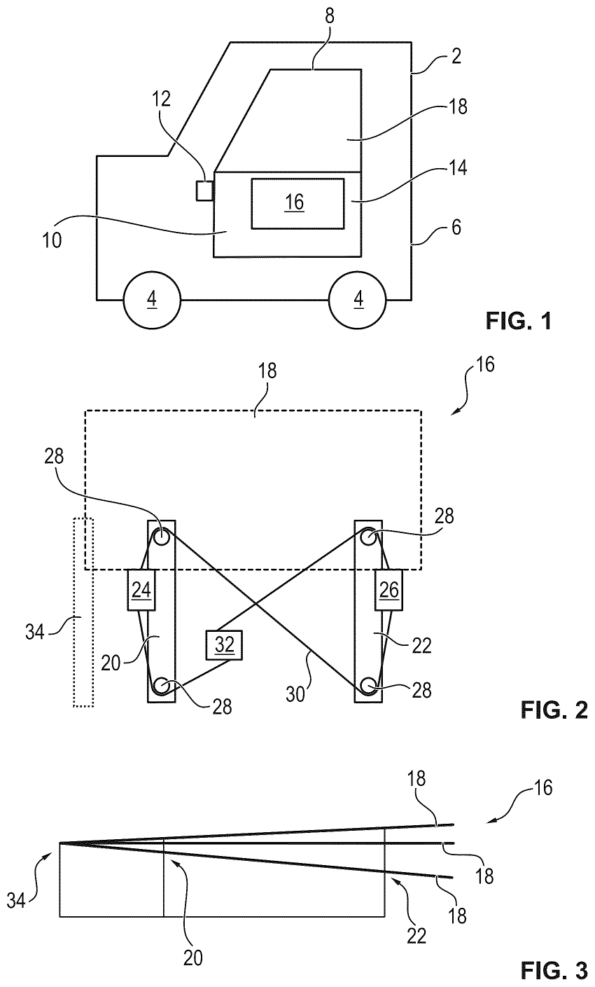

Referring now in detail to the figures of the drawings, in which mutually corresponding parts are denoted by the same reference designations, and first, particularly, to FIG. 1 thereof, there is seen a motor vehicle 2 in the form of a passenger car in a diagrammatically simplified form. The motor vehicle 2 has multiple wheels 4, which make contact with a roadway (not illustrated in any more detail). The wheels 4 are connected via a chassis to a body 6 of the motor vehicle 2, which is formed at least in part from a sheet metal. The body 6 has an opening 8 that can be covered by a door 10. For this purpose, the door 10 is connected to the body 6 by a hinge 12, wherein, due to the hinge 12, the door 10 can be pivoted relative to the body 6 in such a way that the opening 8 in the body 6 is opened up or covered.

The door 10 has a door body 14, which provides the mechanical integrity of the door 10 and which is formed at least partially from a sheet metal. The door body 14, which is part of the body 6, is mechanically fastened to the hinge 12 and at least partially forms an outer skin of the door 10. The door 10 has a window regulator assembly 16 that includes a window pane 18. The window pane 18 protrudes upwardly in a vertical direction beyond the door body 14, and when the window pane 18 and the door 10 are closed, the entire opening 8 is filled by the door body 14 and the window pane 18. In this case, the window pane 18 bears against a seal (not illustrated in any more detail) that surrounds the opening 8. In other words, the window pane 18 is not completely peripherally surrounded by the door body 14, and the door 10 is of frameless configuration. A preload of the window pane 18 gives rise to a force-locking with the seal, in such a way that an ingress of moisture into an interior compartment (not illustrated in any more detail) of the motor vehicle 2 is prevented.

FIG. 2 illustrates, in diagrammatically simplified form, the window regulator assembly 16 that is fastened to the door body 14. The window regulator assembly 16 has a guide rail 20 and a second guide rail 22, which are formed from aluminum or steel and which are offset into the interior of the motor vehicle 2 in relation to the outer skin of the door 10. On the inner side, the guide rails 20, 22 are covered by a door trim panel, in such a way that they are not visible. The two guide rails 20, 22 are parallel to one another and extend substantially in the Z direction in a vehicle coordinate system. Here, the guide rail 20 is disposed in front of the second guide rail 22 in the longitudinal direction of the motor vehicle 2. The guide rail 20 is fastened rigidly to the door body 14, whereas the second guide rail 22 can be inclined, at least to a small degree, relative to a vertical, and/or can be adjusted in the horizontal perpendicularly to the longitudinal direction of the motor vehicle 2.

A slide shoe 24 is mounted longitudinally movably on the guide rail 20, and a second slide shoe 26 is mounted longitudinally movably on the second guide rail 22, which slide shoes, in the example illustrated, are disposed on opposite sides of the respective guide rails 20, 22. A diverting roller 28 is rotatably mounted at each of the ends of each guide rail 20, 22. A cable 30 is guided in crisscrossing fashion by the diverting rollers 28, the cable being driven by an actuating drive 32 which includes a cable drum (not illustrated in any more detail) and an electric motor. Each of the two slide shoes 24, 26 is fastened to the cable 30 in the region between the two diverting rollers 28 that are assigned to the same guide rail 20, 22. Thus, when the actuating drive 32 is operated, the cable 30 is moved, leading to a synchronous movement of the two slide shoes 24, 26 along the respective guide rails 20, 22.

The two slide shoes 24, 26 are connected to the window pane 18, which is furthermore introduced, at an edge, into a guide groove 34 that extends parallel to the guide rails 20, 22. The guide groove 34 is rigidly fastened to, and/or partially formed by, the door body 14. When the actuating drive 32 is operated, the cable 30 is moved, leading to a synchronous movement of the two slide shoes 24, 26 on the respective guide rails 20, 22. The window pane 18 is consequently adjusted, and correspondingly slides along the guide groove 34.

FIG. 3 diagrammatically illustrates, in a plan view, the window regulator assembly 16 in the case of different settings of the second guide rail 22. The second guide rail can be adjusted in the horizontal, perpendicularly to the vehicle longitudinal axis in order to thus adjust the contact pressure of the window pane 18 against the seal around the opening 8. Since the guide groove 34 is fastened rigidly to the door body 14, this leads to a change, albeit slight, in the connection of the window pane 18 to the slide shoe 24 that is mounted on the guide rail 20. Here, in particular, the angle formed between the window pane 18 and the guide rail 20 changes according to the position of the second guide rail 22. The spacing of the window pane 18 to the guide rail 20, which is rigidly fastened to the door body 14, also changes.

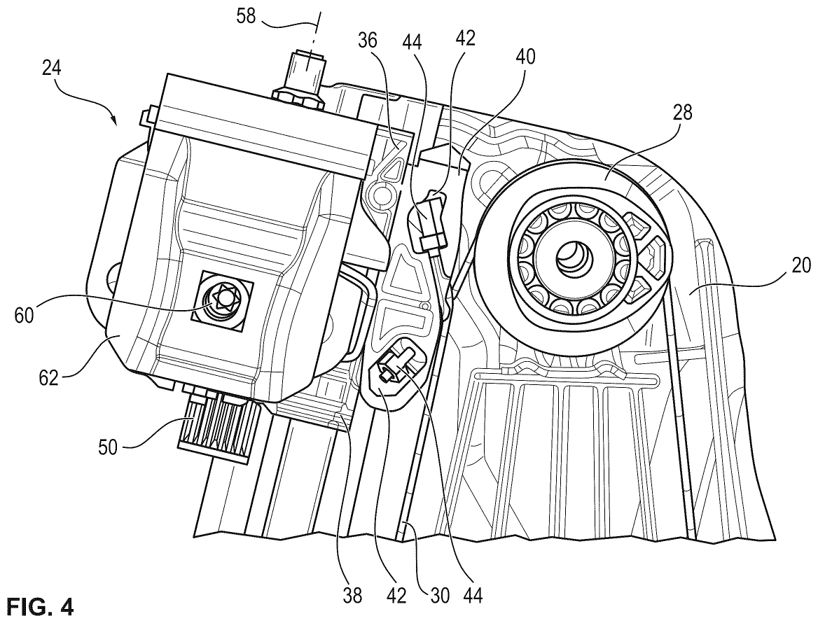

FIG. 4 illustrates the slide shoe 24, which is mounted longitudinally movably on the guide rail 20. The slide shoe 24 has a main bracket 36 mounted on an Z-shaped bent edge of the guide rail 20, for which purpose the main bracket 36 has corresponding structures.

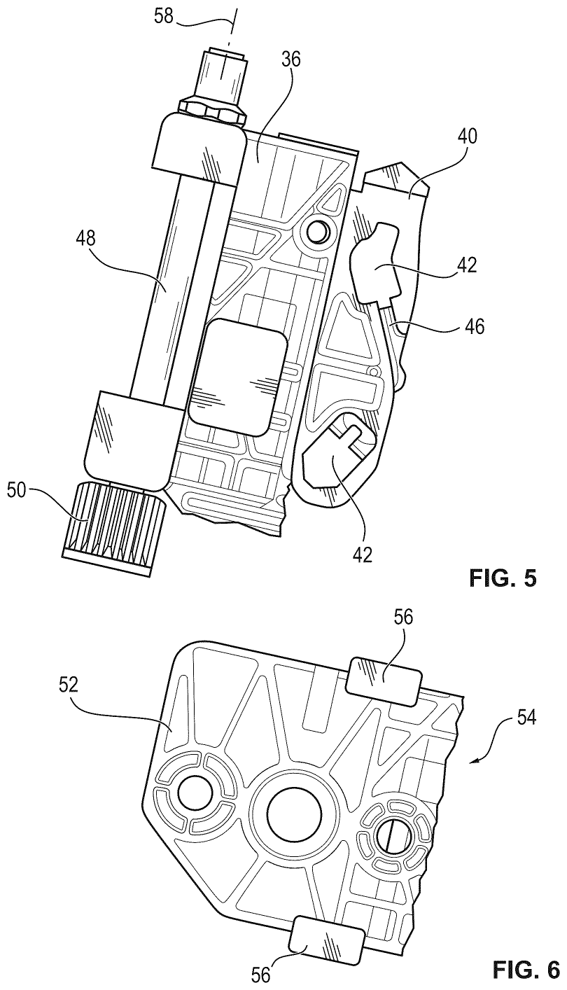

For this purpose, the main bracket 36, which is shown in a side view in FIG. 5, has a body 38 that is manufactured from a metal or a plastics material. A clip, which is manufactured from a plastics material, is inserted into a cutout (not shown in any more detail) of the body 38. The clip engages around the guide rail 20 which, at an edge, has a substantially Z-shaped form. The main bracket 36 is thus mounted rotationally rigidly on the guide rail 20 and cannot be pivoted relative to the guide rail. It is, however, possible for the main bracket 36 to be moved along the guide rail 20. In summary, the main bracket 36 is mounted on, and is in direct mechanical contact with, the guide rail 20.

A cable attachment 40 is fastened rigidly to the main bracket 36 and is formed as a single piece with the body 38. The cable attachment 40 has multiple chambers 42 into which, in the installed state, in each case one sleeve 44 that has been pressed onto the cable 30 is placed. The cable attachment 40 also includes multiple cable guides 46 into which, in the installed state, the cable 30 is placed. The cable 30 is thus held, by the two sleeves 44 fastened thereto, on the cable attachment 40. A pulling action on the cable 30 when the actuating drive 32 is operated does not cause the cable 30 to be removed from the cable attachment 40, because the cable guides 44 have a smaller diameter than the sleeves 42. Force is thus transmitted to the cable attachment 40 and thus to the main bracket 36, leading to an adjustment of the slide shoe 24 relative to the guide rail 20.

On that side of the main bracket 36 which is situated opposite the cable attachment 40, a threaded spindle 48 is mounted on the main bracket. A rotary wheel 50 is fastened to one end of the threaded spindle 48. A clamping bracket 52, illustrated in FIG. 6, of a clamping arrangement 54 is mounted on the main bracket 36 by the threaded spindle 48. For this purpose, the clamping bracket 52 has corresponding holders 56 through the use which spindle nuts (not illustrated in any more detail) are rotatably mounted. The clamping bracket 52 is mounted through the use the holders 56 onto the threaded spindle 48, in such a way that rotation of the threaded spindle 48 causes the position of the clamping arrangement 54 relative to the main bracket 36 to be varied parallel to the guide rail 20. Also, due to the configuration of the holders 56, the clamping arrangement 54 is mounted so as to be rotatable about an axis of rotation 58 that is parallel to the guide rail 20 and to the threaded spindle 48. Here, the threaded spindle 48 is disposed concentrically with respect to the axis of rotation 58. In other words, it is possible for the clamping bracket 52 to be rotated about the threaded spindle 48, at least to a limited extent, by using the holders 56. A pressure plate 62 is fastened to the clamping bracket 52 by a clamping screw 60. The pressure plate 62 is likewise formed from metal and is disposed parallel to the clamping bracket 52. Through the use the clamping screw 60, it is possible to set a maximum spacing of the pressure plate 62 to the clamping bracket 52.

As shown in a perspective view in FIG. 8, a substantially U-shaped clamping component 60 is inserted between the pressure plate 58 and the clamping bracket 50, which clamping component also engages around in each case one of the edges of the pressure plate 58 and of the clamping bracket 50. Thus, those sides of the pressure plate 58 and of the clamping bracket 50 which face toward one another are at least partially lined by the clamping component 60, which is formed from a rubber. The clamping component 60 engages around an edge of the window pane 18. A sandwich arrangement is thus formed from the pressure plate 58, the clamping component 60, the window pane 18 and the clamping bracket 50, and the clamping force acting between the pressure plate 58 and the clamping bracket 50 is set, and thus the clamping component 60 is clamped, by the clamping screw 56. The clamping component 60 in turn holds the window pane 18, which is clamped by the clamping component 60 between the clamping bracket 50 and the pressure plate 58.

In summary, the clamping component 54 is thus mounted adjustably on the main bracket 36, wherein the clamping arrangement 54 is mounted so as to be rotatable relative to the main bracket 36, about the axis of rotation 58 extending parallel to the guide rail 20, by the threaded spindle 48. Here, the threaded spindle 48 is disposed concentrically with respect to the axis of rotation 58. Due to the rotatable mounting of the clamping arrangement 54, it is thus possible, when the second guide rail 22 is adjusted, for the angular offset of the window pane 18 that arises in the region of the guide rail 20 to be compensated, in such a way that distortion arising in the window pane in the region of the slide shoe 24 is reduced.

The clamping arrangement 54 is merely loosely rotatably mounted on the main bracket 36, in such a way that the required angle is set substantially automatically. Here, it is also possible for the clamping arrangement 54 to be adjusted parallel to the guide rail 20 by manual actuation of the rotary wheel 50, whereby enlarged tolerances can be chosen in particular for the positioning of the sleeves 44 on the cable 30, wherein, during installation of the window regulator assembly 16, despite the rigid fastening of the cable attachment 40 to the main bracket 36, the position of the clamping arrangement 52, namely the height in the vertical direction, can be adapted. The rigid fastening increases robustness. Also, due to the rigid fastening of the main bracket 36 to the cable attachment 40, and the position of these relative to one another with respect to the guide rail 20, a tilting moment is reduced, in such a way that jamming of the slide shoe 24 on the guide rail 20 is avoided.

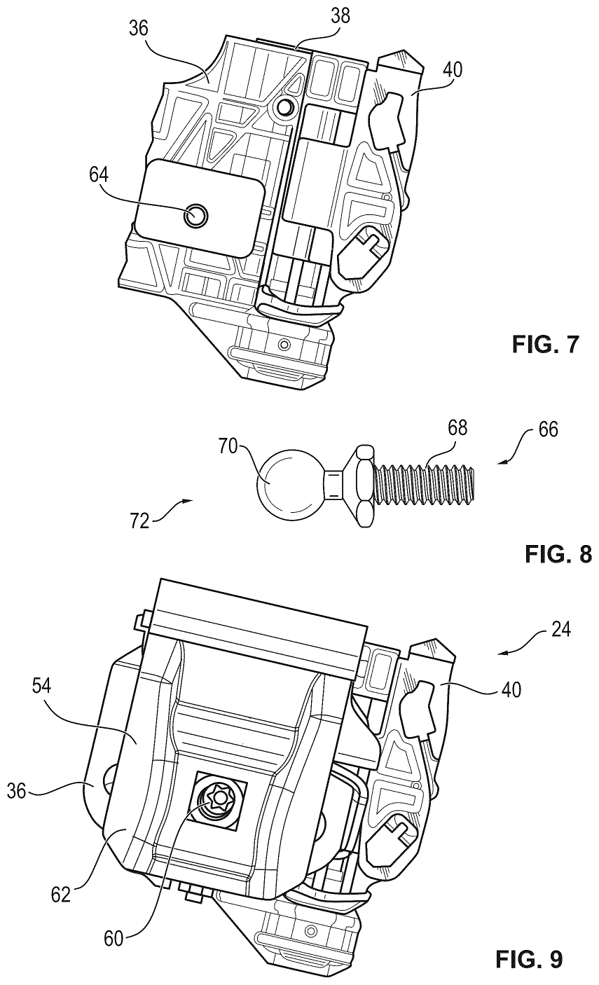

FIG. 7 illustrates a further embodiment of the main bracket 36, which, through the use the threaded spindle 48 that is not illustrated in any more detail, is now mounted so as to be adjustable relative to the cable attachment 40 parallel to the guide rail 20. Here, in the installed state, the cable attachment 40 and the threaded spindle 48 are situated on the same side in relation to the guide rail 20. The body 38 has a hole 64 which extends perpendicular to the guide rail 20 and into which, in the installed state, a ball-head screw 66 illustrated in FIG. 8 is screwed. Here, due to the orientation of the hole 64, the ball-head screw 66 extends obliquely with respect to the guide rail 20.

The ball-head screw 66 has a thread 68 to which, at an end, a ball 70 is attached. The ball 70 forms a part of a ball joint 72, which includes a ball socket (not illustrated in any more detail). The ball socket is part of the clamping arrangement 54, which is therefore, as illustrated in FIG. 9, mounted pivotably on the main bracket 36 by the ball joint 72. The configuration of the pressure plate 62 with the clamping screw 60 corresponds substantially to the aforementioned clamping arrangement 54. In this embodiment of the slide shoe 24, the pivotability of the clamping arrangement 54 relative to the main bracket 36 gives rise to the angular compensation, wherein this takes place substantially automatically.

By screwing the ball-head screw 66 into the hole 64, that is to say by the selection of how much of the thread 68 is situated in the hole 64, it is furthermore possible to adjust the spacing of the clamping arrangement 54 relative to the main bracket 36, in such a way that a lateral offset of the window pane 18 is also compensated.

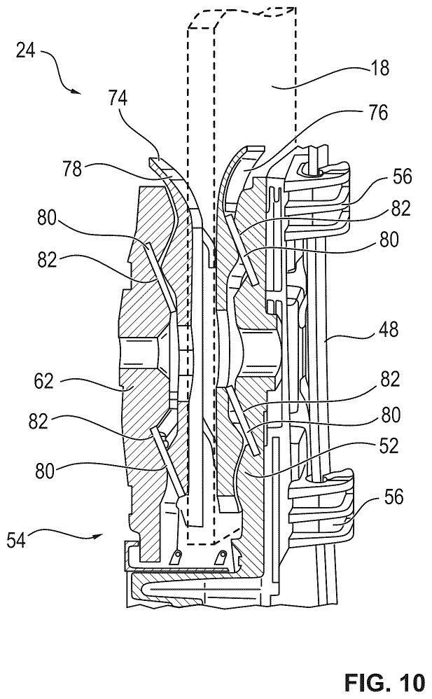

Irrespective of the configuration of the clamping arrangement 54, a clamping component 74 is clamped between the pressure plate 62 and the clamping bracket 52, which clamping component has a first holding surface 76 and a second or further holding surface 78 which are mirror-symmetrical with respect to one another, and which are shown in FIG. 10 in a vertical sectional illustration through the slide shoe 24. Here, the two holding surfaces 76, 78 are substantially planar and are disposed parallel to the pressure plate 62 and to the clamping bracket 52, wherein the upper ends in the vertical direction are bent away from one another. The pressure plate 62 and the clamping bracket 52 are lined on the sides facing toward one another by the two holding surfaces 76, 78, wherein the two holding surfaces 76, 78 protrude vertically upward slightly beyond the pressure plate and clamping bracket. The holding surface 76 is assigned to and mounted on the clamping bracket 52, and the second holding surface 78 is assigned to and mounted on the pressure plate 62.

The window pane 18 is placed between, and is in direct mechanical contact with, the two holding surfaces 76, 78. Here, the window pane 18 is parallel to the two holding surfaces 76, 78. In other words, a sandwich structure is formed from the pressure plate 62, the second holding surface 78, the window pane 18, the holding surface 76, and the clamping bracket 52. Consequently, the clamping component 74 is clamped between the pressure plate 62 and the clamping bracket 52, and the window pane 18 is held, specifically clamped, by the clamping component 74.

The holding surface 76 is mounted movably on and connected to the clamping bracket 52, and the second holding surface 78 is mounted movably on and connected to the pressure plate 62. For this purpose, four bearing wings 80 are connected to each holding surface 76, 78, which bearing wings are inserted into and mounted movably in in each case one corresponding guide slot 82 of the clamping bracket 52 or of the pressure plate 62 respectively. Here, the extent of the guide slots 82 is larger than that part of the particular bearing wing 80 which is inserted into the particular guide slot 82. The two holding surfaces 76, 78 and the bearing wings 80 formed integrally thereon are in this case formed as a single piece from the plastics material.

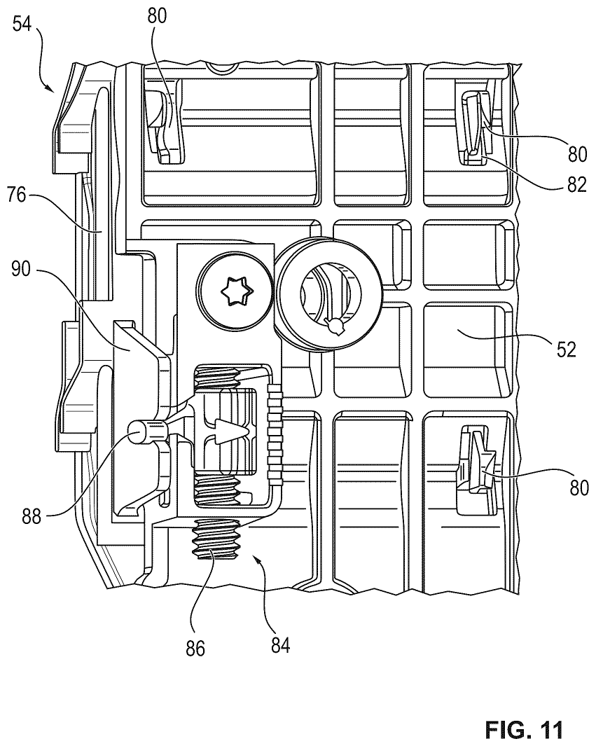

FIG. 11 shows the clamping arrangement 54 from the rear side, that is to say from the side of the main bracket 36 or of the guide rail 20. Here, the guide slots 82 are inclined relative to the two holding surfaces 76, 78 and thus also relative to the clamping bracket 52 and the pressure plate 62, and extend at least partially in the vertical direction. Here, the guide slots 82 enclose an angle of approximately 20° with the guide rail 20. In summary, the clamping bracket 52 and the pressure plate 62 thus have the in each case four associated guide slots 82, into which in each case one of the bearing wings 80, connected to the holding surface 76 or to the second holding surface 78 respectively, is inserted. Here, the guide slots 82 are inclined relative to the holding surface 76. It is thus possible for the holding surfaces 76, 78 to be adjusted obliquely with respect to the clamping bracket 52 and the pressure plate 62. The spacing of the holding surface 76 to the clamping bracket 52 can thus be varied.

An angular gearing 84 that has an adjusting screw 86 is connected to the clamping bracket 52 on the side facing toward the main bracket 36. The adjusting screw 86 acts on a pivotable pin 88 which is inserted into a projection 90, the projection being supported on the holding surface 76 on the side facing toward the clamping bracket 52.

Rotating the adjusting screw 86 causes the spacing of the free end of the pin 88 to the clamping bracket 52, and consequently also the position of the projection 90, to be varied. Here, the adjusting screw 86, which is situated between the clamping bracket 52 and the main bracket 36, is disposed parallel to the clamping bracket 52 and to the guide rails 20 and also parallel to the threaded spindle 48. The adjusting screw 86 can be rotated when the slide shoe 24 is in the installed state.

Due to the angular gearing 84, the adjusting screw 86 acts on the holding surface 76, and the spacing of the holding surface 76 to the clamping bracket 52 is predefined, that is to say set, by the angular gearing. If the free end of the pin 88 is spaced from the clamping bracket 20 to a relatively great extent, the holding surface 76 bears against the clamping bracket 52. If the free end of the pin 88 moves toward the clamping bracket 20, the holding surface 76 is moved away from the clamping bracket 52, wherein the bearing wings 80 slide along the guide slots 82. The second holding surface 78 is merely loosely mounted on the pressure plate 62, and the spacing thereof is set in particular automatically on the basis of the positioning of the holding surface 76 and in particular on the basis of the adjustment of the clamping screw 60. It is thus possible for the position of the window pane 18 relative to the clamping bracket 52 to be varied by the adjusting screw 86, in such a way that, here, too, a lateral offset can be compensated, and thus distortion in the window pane 18 can be avoided.

The invention is not restricted to the exemplary embodiments described above. Rather, other variants of the invention may also be derived from these by a person skilled in the art without departing from the subject matter of the invention. In particular, all individual features described in conjunction with the individual exemplary embodiments may also be combined with one another in other ways without departing from the subject matter of the invention.

The following is a summary list of reference numerals and the corresponding structure used in the above description of the invention:
2 Motor vehicle
4 Wheel
6 Body
8 Opening
10 Door
12 Hinge
14 Door body
16 Window regulator assembly
18 Window pane
20 Guide rail
22 Second guide rail
24 Slide shoe
26 Second slide shoe
28 Diverting roller
30 Cable
32 Actuating drive
34 Guide groove
36 Main bracket
38 Body
40 Cable attachment
42 Chamber
44 Sleeve
46 Cable guide
48 Threaded spindle
50 Rotary wheel
52 Clamping bracket
54 Clamping arrangement
56 Holder
58 Axis of rotation
60 Clamping screw
62 Pressure plate
64 Hole
66 Ball-head screw
68 Thread
70 Ball
72 Ball joint
74 Clamping component
76 Holding surface
78 Second holding surface
80 Bearing wing
82 Guide slot
84 Angular gearing
86 Adjusting screw
88 Pin
90 Projection

1. A window regulator assembly of a motor vehicle, the window regulator assembly comprising:
a guide rail;
a slide shoe longitudinally movably mounted on said guide rail, said slide shoe having a main bracket mounted on said guide rail;
a clamping arrangement including a clamping bracket connected to said main bracket;
a pressure plate disposed parallel to said clamping bracket;
a clamping component clamped between said clamping bracket and said pressure;
said clamping component having a holding surface disposed parallel to said pressure plate;
said holding surface and said clamping bracket defining an adjustable spacing therebetween; and
a window pane held by said clamping component.

2. The window regulator assembly according to claim 1, wherein said holding surface is mounted on said clamping bracket.

3. The window regulator assembly according to claim 2, which further comprises an adjusting screw mounted on said clamping bracket and acting on said holding surface.

4. The window regulator assembly according to claim 3, which further comprises an angular gearing having said adjusting screw, said angular gearing being connected to said clamping bracket, and said adjusting screw being disposed parallel to said clamping bracket.

5. The window regulator assembly according to claim 2, which further comprises bearing wings connected to said holding surface, said bearing wings each being inserted into a respective one of a plurality of guide slots formed in said clamping bracket, said guide slots being inclined relative to said holding surface.

6. The window regulator assembly according to claim 2, wherein said clamping component has a further holding surface connected to said pressure plate.

7. The window regulator assembly according to claim 1, wherein said clamping arrangement is mounted adjustably on said main bracket.

8. The window regulator assembly according to claim 7, wherein said clamping arrangement is mounted rotatably relative to said main bracket about an axis of rotation extending parallel to said guide rail.

9. The window regulator assembly according to claim 7, which further comprises a ball joint mounting said clamping arrangement pivotably on said main bracket.

10. A slide shoe of a window regulator assembly, the slide shoe comprising:
a main bracket configured to be mounted on a guide rail, said main bracket having a clamping arrangement, said clamping arrangement including a clamping bracket connected to said main bracket;
a pressure plate disposed parallel to said clamping bracket;
a clamping component disposed between said clamping bracket and said pressure plate for holding a window pane;
said clamping component having a holding surface disposed parallel to said pressure plate; and
said holding surface and said clamping bracket defining an adjustable spacing therebetween.
